(19) United States
(12) Patent Application Publication
(10) Pub. No.: US 2005/0120839 A1
(43) Pub. Date: Jun. 9, 2005

(54) Method of and device for trimming panels

(76) Inventor: Arvid M. Thompsen, Lyngdal (NO)

Correspondence Address: DERGOSITS & NOAH LLP;Attn: Andrew B. Schwaab, Suite 1450, Four Embarcadero Center, San Francisco, CA, 94111, US

(21) Appl. No.: 10/729,613

(22) Filed: Dec. 4, 2003

(51) Int. Cl. B26D 1/00

(52) U.S. Cl. 83/13; 83/361

(57) ABSTRACT

A method of and device for aligning a plate (1) provided with a decorating pattern, prior to trimming, where the trimming of at least one of the edges of the plate (1) must be aligned with respect to the decorating pattern, and where the decorating pattern of the plate (1) is provided with an alignment line (14), preferably during the application of the decorating pattern, the plate (1) being arranged and held on an adjustment table (22) prior to trimming, whereupon the adjustment table (22) with the plate (1) is aligned with respect to the alignment line (14) before the plate (1) is trimmed.

This invention regards a method of trimming panels. More exactly, it concerns a method of processing wallboards, one side of which is provided with a pattern comprising seamlike portions along its joining edges. The invention also comprises a device for implementing the method.

Wallboards exist in several designs and are preferably provided with decoration suitable for the application, on one side.

A wallboard that has gained extensive use comprises a core panel made from waterproof plywood, with a decorating laminate glued to one side and a sealing laminate glued to the opposite side.

The thickness of the plywood panel is typically nine millimeters, while the thickness of the laminate is in the order of one millimeter. The side edges of the wallboard are provided with a groove, alternatively a tongue for joining together, and, as a result of their resistance to humidity and mechanical strength, the panels have been approved for use in damp rooms without requiring an additional damp course.

It is known to provide this type of wallboards with a ceramic tile-like pattern, where the seams of the patterns are arranged along the joining edges of the wallboards. It has been found that the joint seam between two adjacent panels is least visible if placed in a seam-like portion.

The width of the seam in the panel joint must be substantially uniform along the entire longitudinal extent of the seam in order to present an acceptable appearance. Due to production engineering problems related to different swelling in the various parts of the decorating laminate during production, the production of laminate panels with a relatively narrow seam along the wallboard edge has according to prior art caused great difficulties. This difference in swelling can cause the finished joint to have a variable seam width. In this connection, narrow seams mean a seam width in the order of five millimeters, such as is conventionally used in the case of wall mounted ceramic tiles.

When the wallboard is to be trimmed along the longitudinal edges prior to milling the tongue and groove, it is common according to prior art to move the wallboard along stationary rotating saw blades. It has been found that such a method is not sufficiently accurate for the production of wallboards where the wallboard is provided with a narrow seam decoration along its joining edges.

The object of the invention is to remedy the disadvantages of prior art.

The object is achieved in accordance with the invention, by the characteristics stated in the description below and in the following claims.

Due to the somewhat variable dimensions of the decorating laminate it is necessary to align each wallboard separately prior to trimming. After alignment, the wallboard is held on a stationary support, whereupon guide supported saw blades are displaced cuttingly along the edges of the stationary wallboard.

In a preferred embodiment the production process involves adding at least one alignment line to the decorating laminate, extending in the longitudinal direction of the wallboard, and possibly also in the transverse direction of the wallboard. The alignment line is of a design that allows it to be read by an optical reader.

When the wallboard has been placed on a trimming table and fixed to the trimming table, the fixing plate of the trimming table is displaced relative to the saw blades, preferably by means of servo motors, until the optical readers senses that the wallboard is in the correct position.

The saw blades are then displaced cuttingly along the edges of the wallboard by means of their relatively accurate guides.

The trimmed edges constitute an accurate reference for the subsequent processing, which includes milling the tongue and groove in the edges of the wallboard.

In the following, a description is given of a non-limiting example of a preferred method and embodiment illustrated in the accompanying drawings, in which:

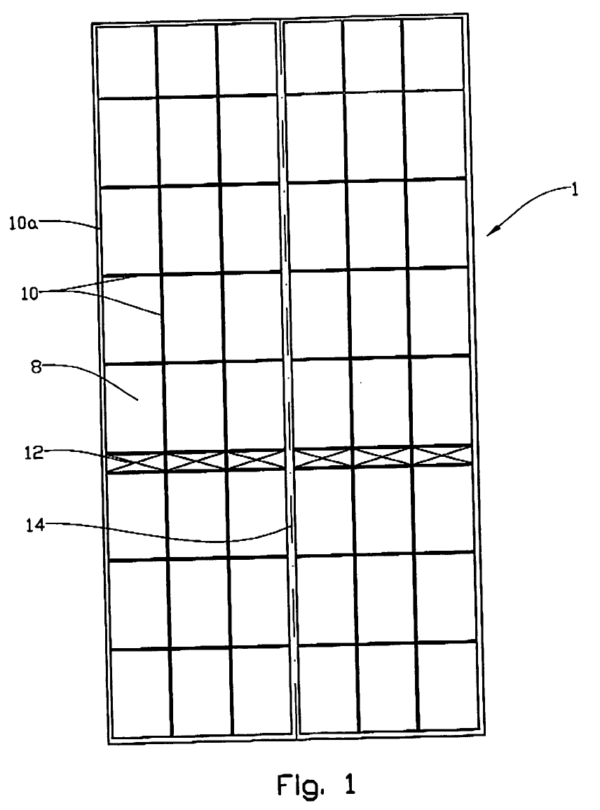

FIG. 1 shows the decorating laminate side of a wallboard in the untrimmed and uncut state;

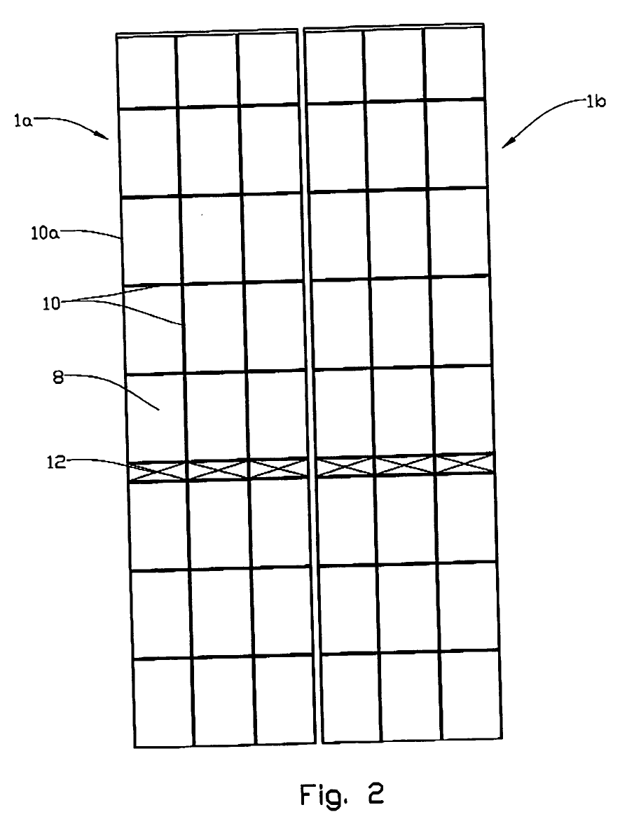

FIG. 2 shows the wallboard of FIG. 1 after the trimming and cutting has taken place;

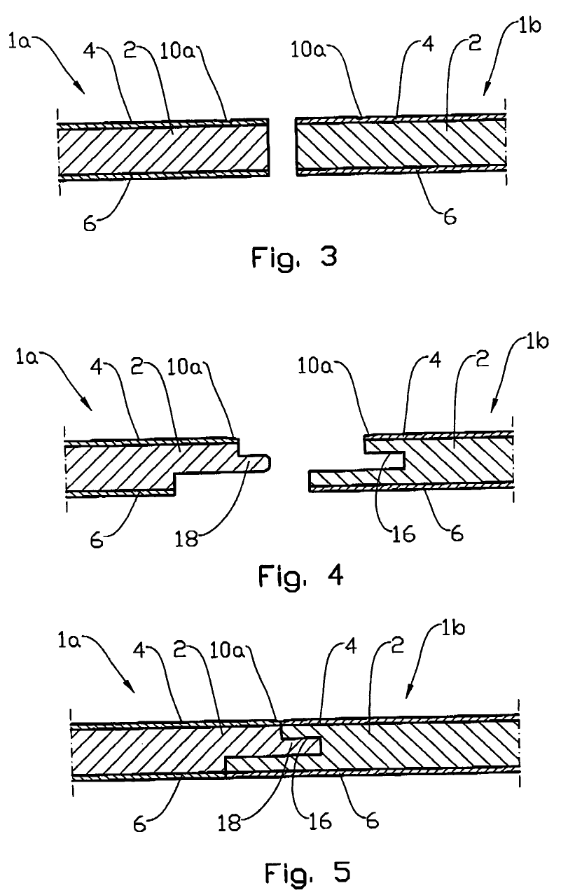

FIG. 3 shows a cross section of the facing edges of two wallboards, on a larger scale;

FIG. 4 shows the wallboard of FIG. 3 after a tongue and groove respectively have been milled in the edges;

FIG. 5 shows the wallboard of FIG. 4 after the wallboards have been joined;

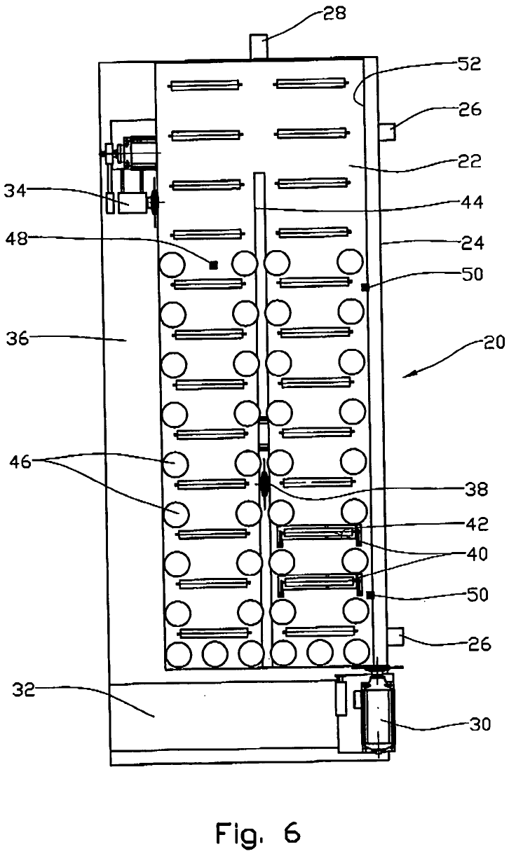

FIG. 6 is a simplified plan view of a trimming table;

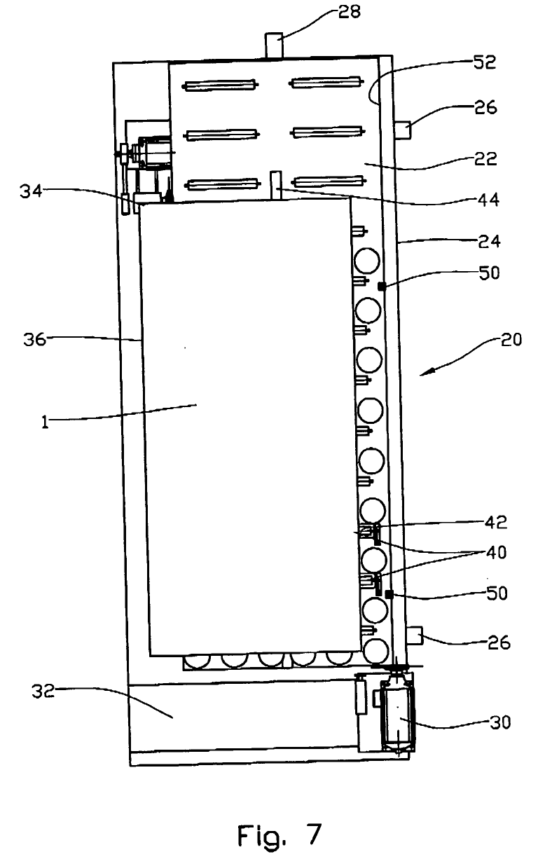

FIG. 7 shows the trimming table of FIG. 6 as a wallboard enters the table;

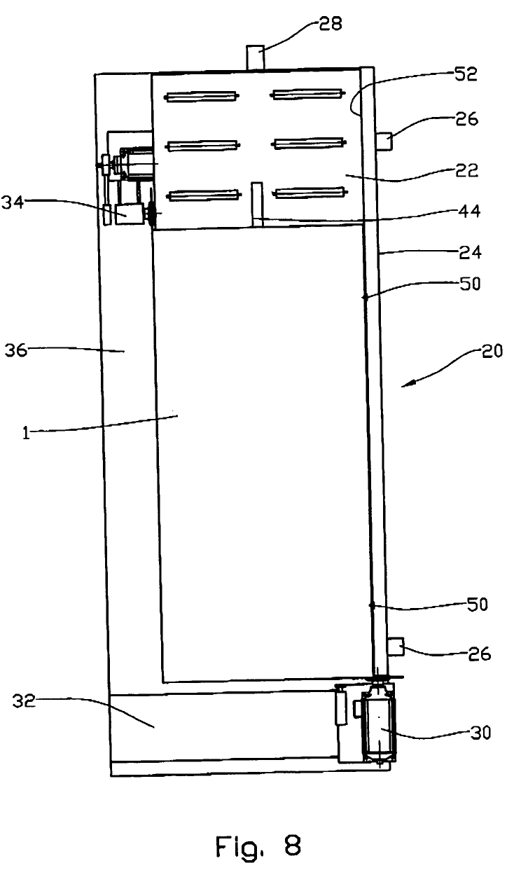

FIG. 8 shows the trimming table of FIG. 6 after the wallboard has come to an impact against a guide strip and is being aligned by means of servo motors; and

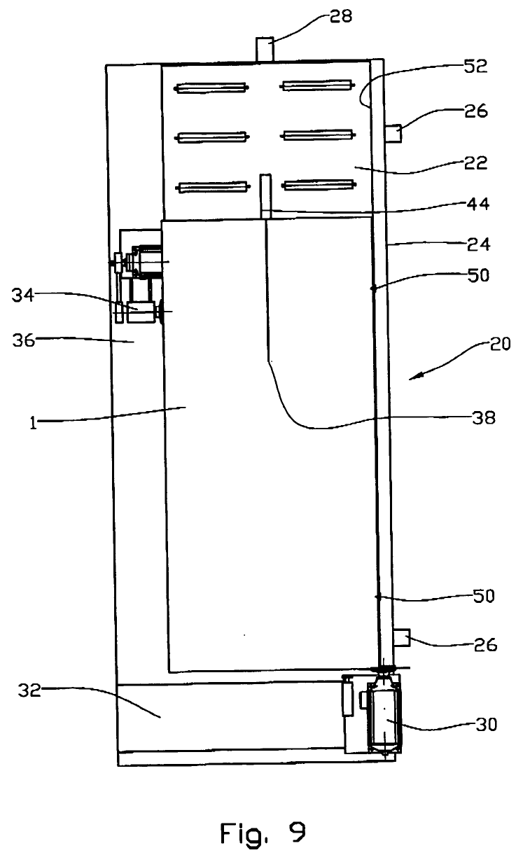

FIG. 9 shows the trimming table of FIG. 6 while the wallboard is being trimmed and cut.

In the drawings, reference number 1 denotes a wallboard comprising a core panel 2 of waterproof plywood with a decorating laminate 4 glued to one side and a sealing laminate 6 glued to the opposite side.

The decorating laminate 4 of the wallboard 1 is designed in a ceramic tile pattern 8 in which the seamlike portions, hereinafter denoted seam 10, are slightly recessed relative to the remaining of the surface.

The ceramic tile pattern 8 in FIGS. 1 and 2 also comprises a border 12 that forms part of the decorating laminate 4. The seam 10a which is to be located at the assembly joint between two adjacent wallboards 1 has been formed with half of its seam width on either wallboard 1.

In FIG. 1, the wallboard 1 is shown in the untrimmed state, prior to trimming and cutting. An alignment line 14 runs parallel to the seam 10 along the middle of the wallboard 1.

In order to illustrate the further processing of the wallboards 1, FIG. 4 shows the wallboards after the facing edges of the wallboards 1 have been machined to give them a groove 16 and a tongue 18 respectively. In FIG. 5, two wallboards 1 are shown after assembly, where the seam 10a at the joint is formed by half a seam width from either wallboard 1.

The wallboard 1 is trimmed and cut by means of a trimming table 20. The trimming table 20 comprises an adjustment table 22 displaceably connected to the base 24 of the trimming table 20, and which is controlled by means of two side servo motors 26 and one end servo motor 28.

An end saw 30 is displaceable in the transverse direction of the trimming table 20 through use of a first guide 32, and is arranged to be able to trim one end edge of the wallboard 1.

A side saw 34 is displaceable in the longitudinal direction of the trimming table 20 by use of a second guide 36, and is arranged to be able to trim one lateral edge on the wallboard 1.

A cutting saw 38 is displaceable in the longitudinal direction of the trimming table 20 through use of a third guide (not shown), and is arranged to be able cut the wallboard 1 into two parts 1a and 1b, see FIG. 3.

A number of conveyor rollers 40 are rotatable supported in the adjustment table 22, in the active position projecting slightly above the surface of the adjustment table 22 and the suction discs 46 through openings 42. The conveyor rollers 40 are arranged so as to be able to transport the trimmed wallboards 1a, 1b out of the trimming table 20.

In the operating position, the saw blade of the cutting saw 38 projects through an elongated slot 44 in the adjustment table 22.

A number of suction discs 46 are designed to keep the wallboard 1 fixed to the adjustment table 22 during the alignment and trimming of the wallboard 1.

A first optical reader 48 and two other optical readers 50 connected to the base 24 are designed to read alignment lines 14, see FIG. 1.

The optical readers 48, 50 control the servo motors 26, 28 in a manner that is known per se, by means of a control system (not shown).

The saws 30, 34 and 38 and the optical readers 48 and 50 are carefully aligned with respect to each other in order to be able to trim the wallboard 1 with the required degree of accuracy.

A wallboard 1 to be trimmed is moved in over the adjustment table 22 of the trimming table 20, see FIG. 7, until it abuts an alignment ledge 52, see FIG. 8.

Then the wallboard 1 is fixed to the adjustment table 22 by means of the suction discs 46. The adjustment table 22 is displaced longitudinally and transversely by means of the end servo motor 28 and the side servo motors 26 respectively, until the optical readers 50 and 48 have located their corresponding alignment line 14 and an alignment line (not shown) added in the transverse direction of the wallboard 1, respectively.

Thus the wallboard 1 is in the correct trimming position. The end saw 30 first trims one end, whereupon the side saw 34 and the cutting saw 38 carry out their respective cutting operations.

After the trimming has been completed, the suction discs 46 are released, whereupon the wallboards 1a, 1b are moved out of the trimming table 20.

The trimmed edges of the wallboards 1a, 1b are located at an exact distance from the seam 10a and form a reference for the further processing of the wallboard 1.

1. A method of aligning a plate (1) provided with a decorating pattern, prior to trimming, characterized in that the decorating pattern of the plate (1) is provided with an alignment line (14), preferably during the application of the decorating pattern, which line is subsequently used when aligning the plate (1).

2. A method in accordance with claim 1, characterized in that the plate (1) is arranged on and fixed to an adjustment table (22) prior to trimming, whereupon the adjustment table (22) with the plate (1) is aligned with respect to the alignment line (14) before the plate (1) is trimmed.

3. A trimming table device (20) comprising a base (24) and an adjustment table (22), wherein a plate (1) is held to the adjustment table (22), characterized in that the adjustment table (22) is displaceably connected to the base (24) by at least one servo motor (26, 28), wherein at least one servo motor is controlled by a reader (48, 50), the reader (48, 50) being designed to read an alignment line (14) located on the plate (1).

4. A device in accordance with claim 3, characterized in that at least one trimming saw (30, 34) and/or cutting saw (38) is displaceably connected to the base (24) by means of respective guides (32, 36).
